(19) United States
(12) Patent Application Publication
(10) Pub. No.: US 2004/0194147 A1
(43) Pub. Date: Sep. 30, 2004

(54) Broadband multi-interface media module

(76) Inventors: Jeff Craven, Cumming, GA (US); Mark Bugajski, Norcross, GA (US)

Correspondence Address: John Doughty, ARRIS International, Inc., 3871 Lakefield Drive, Suwanee, GA, 30024, US

(21) Appl. No.: 10/814,029

(22) Filed: Mar. 31, 2004

Related U.S. Application Data
(60) Provisional application No. 60/459,103, filed on Mar. 31, 2003.

(51) Int. Cl. H04N 7/20; H04N 7/173

(52) U.S. Cl. 725/111; 725/113; 725/120

(57) ABSTRACT

Cable modem circuitry is connected via a bus interface to decoder circuitry in a set top box to receive various types of content and distribute the content to outputs corresponding to the content type. The outputs include video, audio, data (USB host), telephony and asynchronous interface. The content is received on a single broadband connection from a single service provider rather than multiple connections from multiple service providers. The DOCSIS protocol, and features that are a part thereof, are used to facilitate efficient transmission of content to a subscriber.

Content, including telephony, video, audio and data may be stored or received at a provider's central location for subsequent transmission to a subscriber in response to a request for the content. DOCSIS DsX and DCC at the cable modem are used to enhance the performance and quality of service of the delivery of content.

### CROSS REFERENCE TO RELATED APPLICATION

This application claims the benefit of priority under 35 U.S.C. 119(e) to the filing date of Craven, et. al., U.S. provisional patent application number 60/459,103 entitled “DOCSIS Multi-interface Media Module”, which was filed Mar. 31, 2003, and is incorporated herein by reference in its entirety.

### FIELD OF THE INVENTION

The present invention relates generally to transmission of information in a communication network, and more specifically to transporting multimedia content along with other types of data over a broadband network to broadband connection.

### BACKGROUND

There are many types of content that subscribing consumers desire to receive from service providers. For example, most consumers in the United States subscribe to basic telephony services from a telephone company. A large number of consumers also subscribe to some sort of video delivery service, including community antennae television (“CATV”), also known as cable television, and/or satellite television. In addition, many consumers are subscribers to an Internet Service Provider (“ISP”), which provides high-speed data connectivity to the Internet through a user's personal computer.

To receive these services, for example, a consumer typically subscribes with a telephone company for telephony services, a cable or satellite company for video delivery, and a separate internet service provider for data. Not only does this typically involve having multiple providers who's bills must be kept track of and paid monthly, but a typical residence will have a corresponding number of connection-related-equipment devices mounted on the exterior, or within the interior, of the residential structure with each having a separate means of connecting the external device to user devices, such as telephones, television sets and computers within the residence.

In the current regulatory environment, service providers are attempting to market and deliver competing services that differ from their traditional services on their existing platform. For example, telephone companies offer high speed data services over Digital Subscriber Lines (“DSL”) that utilize existing telephony twisted-pair lines. Cable television companies are offering data and telephony services over their existing coaxial (“coax”) and hybrid fiber coaxial (“HFC”) lines. Satellite television companies offer Internet data connections using their existing infrastructure.

These implementations typically utilize communication transport circuitry and software in an enclosure that is optimized for delivery to a television set, a telephone set, or a personal computer. For example, digitized multimedia delivery destined for a television is facilitated using MPEG Transport (“MPEG-TS”). Multimedia delivery destined for a personal computer is usually facilitated using any number of TCP/IP-based, non-real-time mechanisms.

Today's methods of providing the consumer with digital video services over cable TV, high speed digital subscriber line or satellite dish typically require each TV set to be accompanied by a set-top-box (herein referred to as Multimedia Terminating Device, or “MTD”). The MTD that are available today are typically based on multimedia delivery via MPEG-TS models. They house a significant number of specialized electronics and software that result in high unit costs. The units are mostly proprietary in nature and, therefore, unable to take advantage of standards and their associated economies of scale.

MPEG-TS is essentially one-way broadcast in nature and uses a significant amount of downstream frequency spectrum. Thus, high-speed data and/or telephony typically cannot be used in the same spectrum simultaneously with MPEG-TS. Not only does this result in an inefficient use of available spectrum, but requires that a service provider who offers multiple types of service maintain multiple and different infrastructure architectures to support their customers.

Most of today's solutions for providing the consumer with high-speed data require a network interface device such as a cable modem or DSL modem. To date, the use of these data services have been for web surfing and other internet, PC-based services. No services for providing multimedia directly to a television via a cable modem architecture are commercially available.

Many solutions for providing multimedia content to the Personal Computer have and continue to be available. Success has been marginal. Part of the reason is that consumers tend to consider the television to be a “sit-back,” or passive entertainment device, whereas, the personal computer is considered a “lean-forward,” or active tool used to increase productivity. Thus, consumers typically consider their television as the desired device for viewing multimedia entertainment content rather than a PC. In addition, the bandwidth generally available for typical data services is not large enough to accommodate high-quality video delivery without significant jitter and delay.

In addition, providers often do not have the means for obtaining multiple types of content for delivery to a consumer. For example, a telephone company may not be able to obtain video programming using existing equipment that a telephony company typically uses; an Internet service provider may not have access to telephony networks or to video content.

Accordingly, there is a need in the art for a method and system that efficiently converges the delivery of multiple types of service on a broadband connection provided by a single service provider so that a consumer has only one type of communication network equipment and one monthly bill to pay. In addition, there is a need in the art for a method and system for obtaining multiple types of content by a single provider.

### SUMMARY

A method and system described for delivering multimedia content, along with data and voice, over a broadband network connection and outputting various types of content from a subscriber device having output connections corresponding to a variety of interface types. A broadband transport mechanism and protocol is used over a broadband network connection and is capable of providing multimedia content, including video and audio, voice and data services from a single subscriber device. For example, in the preferred embodiment, the Data Over Cable Service Interface Specification (“DOCSIS”) standard protocol is used to connect a Cable Modem Termination System (“CMTS”) to a Cable Modem (“CM”). Multimedia content is provided from dedicated servers at or to the CMTS and the content is sent downstream to the CM. The content, along with data and voice, is digitized into digital information messages/signals, and the digital information signals are assembled/formatted according to the DOCSIS protocol. The DOCSIS-formatted messages are sent over a broadband network, including to a plurality of cable modems at subscriber locations, and from one to a plurality of CMTSs at a service provider's head end.

The CM is integrated into a device that receives the DOCSIS protocol data and strips the DOCSIS-related signaling/messaging-format information, leaving only the content payload. The content payload is forwarded to a decoding section via a bus interface. The decoder decodes the content that may be encoded in a format, such as, for example, MPEG compression for video content, or mp3 for audio. Then, the decoded video signal is provided to at least one video output to which a video device, such as a television or video recorder, can be connected. The decoder can also provide the multimedia signal at a digital output, such as Universal Serial Bus (“USB”) for connecting to a personal computer. The decoder also provides an audio output for stereo or other multimedia audio content. Thus, a single device receives content from a single broadband connection using a broadband protocol, such as DOCSIS, and is capable of providing a variety of outputs for user devices, including video for television, audio for stereo and data for a computer. Furthermore, some DOCSIS features, such as, for example, Dynamic Service Flow (“DsX”) messaging and Dynamic Channel Change (“DCC”) are used to enhance the delivery of content to the broadband-connected device.

### BRIEF DESCRIPTION OF THE DRAWINGS

FIG. 1 illustrates a system for providing multimedia, voice and data over an HFC network.

FIG. 2 illustrates a block diagram of a MTD for providing multimedia content via a broadband network connection.

FIG. 3 illustrates use of a DOCSIS dynamic service flow feature for facilitating management of downstream bandwidth.

FIG. 4 illustrates use of a DOCSIS dynamic channel change feature for facilitating management of downstream channel selection.

### DETAILED DESCRIPTION

As a preliminary matter, it will be readily understood by those persons skilled in the art that the present invention is susceptible of broad utility and application. Many methods, embodiments and adaptations of the present invention other than those herein described, as well as many variations, modifications, and equivalent arrangements, will be apparent from or reasonably suggested by the present invention and the following description thereof, without departing from the substance or scope of the present invention.

Accordingly, while the present invention has been described herein in detail in relation to preferred embodiments, it is to be understood that this disclosure is only illustrative and exemplary of the present invention and is made merely for the purposes of providing a full and enabling disclosure of the invention. This disclosure is not intended nor is to be construed to limit the present invention or otherwise to exclude other embodiments, adaptations, variations, modifications and equivalent arrangements, the present invention being limited only by the claims appended hereto and the equivalents thereof.

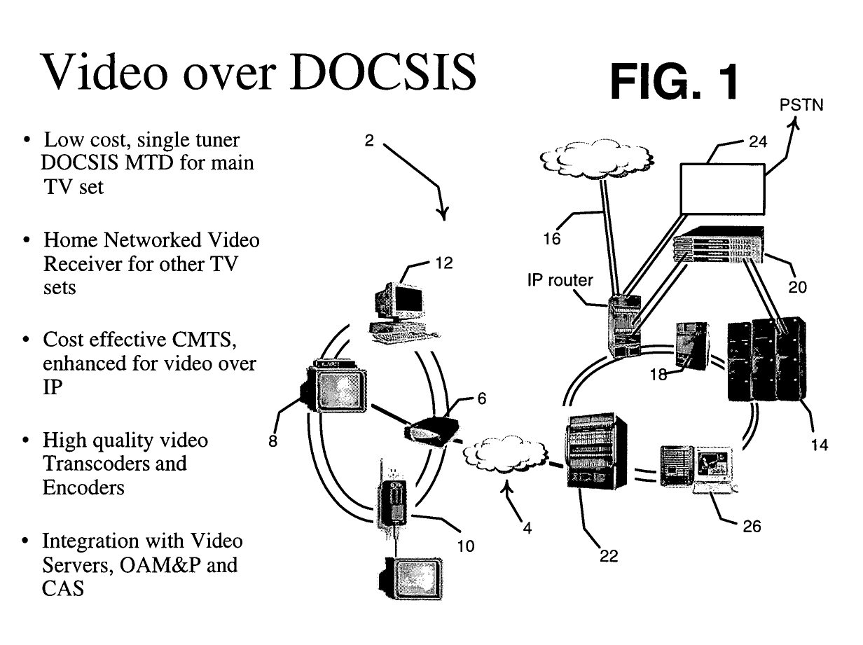

Turning now to the figures, FIG. 1 illustrates a system 2 for providing video and other multimedia content, along with data and telephony services over a broadband network 4 to a subscriber network interface device 6. A subscriber connects multiple types of user interface devices, such as, for example, a television 8, a LAN video receiver 10 and a personal computer 12 to the network interface device 6. Content may originate at a dedicated multimedia content server 14 at a provider's central location, or head end. Alternatively, content may be received from an external network 16, such as an intranet or the Internet, for example. Content may also be received from another provider via network 16 and either stored to server 18 or stored to server 14 after being translated via translator 20. Content requested through a subscriber device 6 is received at CMTS 22, which formats requested content into a DOCSIS message and transmits the message downstream to device 6.

CMTS 22 can receive any type of content, be it voice from a telephony network through telephony gateway 24, video server 18 or network 16. The content is then converted into DOCSIS-format messages/signals and transported from CMTS 22 to a requesting user at the user's network interface device 6. Network interface device 6 receives the DOCSIS-formatted messages and strips away the DOCSIS format information, leaving the payload of the DOCSIS message(s), which is/are the requested content in its native format, which may be encoded or not encoded. The content is then decoded within the network device 6, which may also be referred to as a Multimedia Terminating Device, and routed to the appropriate output port, depending on the type of content. The native encoding of the content may be under the control of the Provisioning and Management System 26, which may determine whether a particular user's interface device is a digital or analog television, a standard stereo or BTSC encoded device, or a computer, for example. Home LAN connection device 10, connected to a USB host port of network interface device 6, may be a wireless receiver, a HOMEPLUG transmitter, an Ethernet connection, or other similar device known in the art.

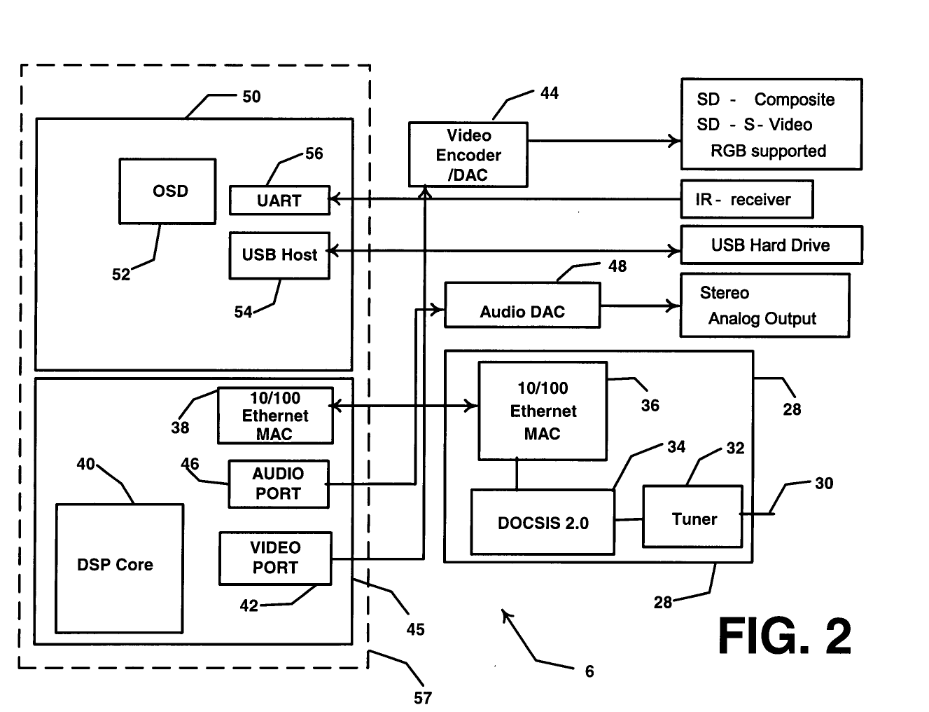

Turning now to FIG. 2, a block diagram of the internal components of network interface device 6 is shown. Block 28 shows the network interface portion, which includes broadband communication circuitry. In the preferred embodiment, the interface portion 28 includes typical components found in a cable modem for DOCSIS signal transport. The cable network connects at network connection port 30 where the tuner 32 provides tuning for the appropriate downstream and upstream communication channels, as known in the art. DOCSIS format translator 34 strips incoming messages of the DOCSIS format information, as known in the art, and provides the resulting payload to MAC 36 which communicates via a bus interface to the decoding system. The messages received at decoder MAC 38 are forwarded to digital signal processor 40 for processing according to the type of content received. For example, if the content received is video content, it may typically be encoded in an MPEG format, known in the art. Processor 40 then performs MPEG decoding on the received video content and provides the decoded content to one of video ports 42. From these video ports 42, the output signal is routed through a digital to analog converter (“DAC”) 44, for forwarding to analog devices, such as an analog television set.

The components of block 45 are grouped together in what is referred to as the decoder DSP portion. Decoder DSP portion 45 decodes received multimedia content and provides video to video ports 42, or audio content from digital audio interface 46, which forwards decoded audio content to audio DAC 48 for providing the audio content as an analog output to traditional stereo equipment.

If a digital output is desired, for example to provide content to a hard disk recording device or a personal computer, or to provide graphical overlays, such as a programming guide for example, host portion 50 uses on screen display driver (“OSD”) 52, also referred to as a graphics processor, known in the art. The content messages processed by OSD 52 are forwarded to USB host 54 for driving a USB device such as a hard disk recorder that can record content for playback at a later time. Asynchronous interface 56 provides an interface for external devices such as, for example, an infrared remote control. Decoder DSP portion 44 and Host portion 50 are collectively referred to as decoder 57.

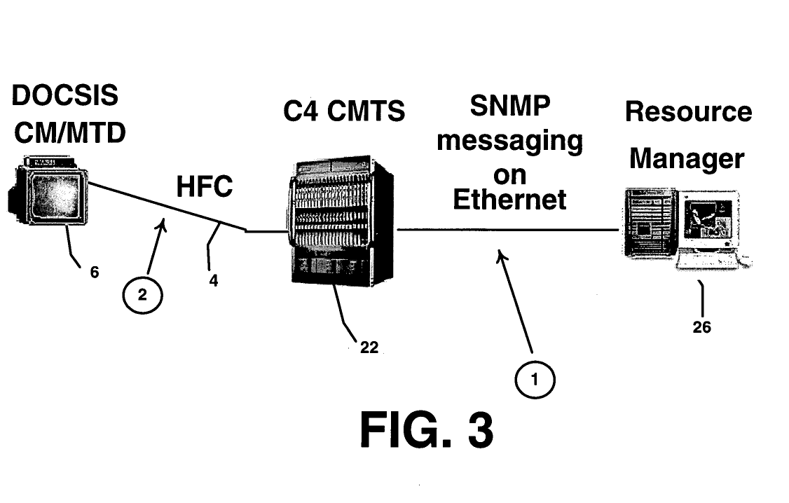

Turning now to FIG. 3, the figure illustrates an aspect in which a DOCSIS feature, DsX, can be implemented to facilitate downstream transport of video multimedia content. Resource manager 26 receives a message that a subscriber desires particular video content. This message may be received via CMTS 22 from cable modem 6, or from the internet 16 as shown in FIG. 1. When the resource manager receives the message for video request, an SNMP message is sent to CMTS 22 to write values the DsX Management Information Base (“MIB”) at step 1, as known in the art. The CMTS 22 sends the appropriate command messages to modem 6 to establish the appropriate service flow for the requested video content at step 2. Thus, the channel bandwidth and other parameters related to efficient transport of video, including Quality of Service (“QoS”) and security methods for example, are sent to modem 6 over HFC 4 using standard DOCSIS features.

Another aspect uses Dynamic Channel Control (“DCC”) to select an appropriate downstream channel having an appropriate amount of bandwidth for the content requested by the subscriber. The process follows the same architecture shown in FIG. 3, but instead of DsX commands being configured in the MIB, a DCC command is generated that allows modem 6 to quickly change QAM channels. While DCC is a DOCSIS feature known in the art, it will be appreciated that DCC is typically implemented at CMTS 22. As described, using the architecture shown in FIG. 3, the DCC MIB is configured within the CM so that modem 6, or the CMTS 22, can select an appropriate channel based on the bandwidth required for the requested content. Thus, a DOCSIS feature designed for use at the CMTS is implemented at the cable modem 6 to facilitate efficient transport of content.

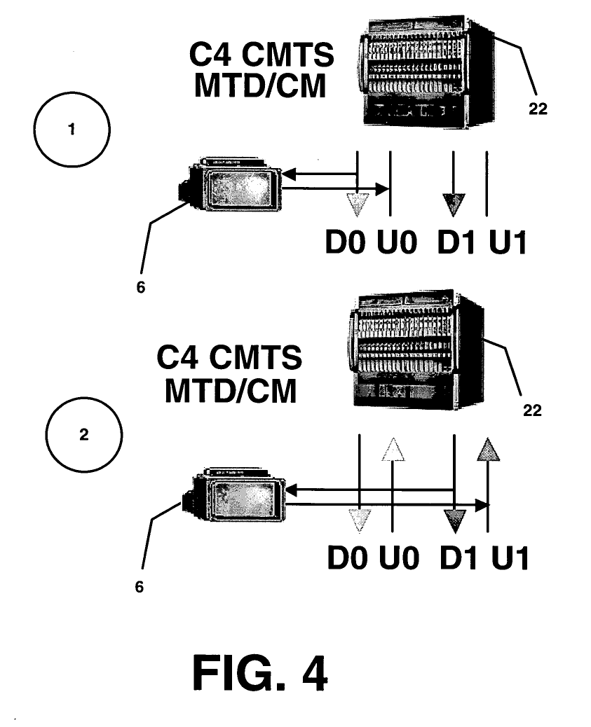

Turning now to FIG. 4, the advantageous use of DCC is shown. As will be appreciated by those in the art, a MTD/CM 6 on a fiber node typically has access to at least two downstream channels (D0 & D1) & at least two upstream channels (U0 & U1), where D0/U0 define one MAC domain and D1/U1 define another MAC domain. To illustrate the beneficial use of DCC, it is assumed for sake of example that CM 6 is tuned to D0/U0 in a first scenario. The subscriber using CM 6 desires content that uses a 1.5 Mbps video stream, but there is not enough bandwidth available on D0 in scenario 1. However, there is enough bandwidth available on D1, as shown in scenario 2. Resource manager 26 shown in FIG, 1, at the provider's head end can recognize this condition and instruct the CMTS 22 (via SNMP) to send a DCC message to CM 6 so that it re-tunes to D1/U1 as described above. The CMTS 22 routing table/arp cache, known in the art, keeps track of this channel change. Accordingly, the video stream is successfully sent to the subscriber on D1 instead of D0. It will be appreciated that DCC is typically implemented in a CMTS/CM system at the head end instead of the CM end, by changing the channel for downstream traffic at the CMTS and instructing the CM to tune to the designated channel. The present aspect is advantageous because it frees up resources at the head end that would otherwise be used for channel changing and allows the CM 6 to decide which channel(s) to use based on the type of content desired by the subscriber.

These and many other objects and advantages will be readily apparent to one skilled in the art from the foregoing specification when read in conjunction with the appended drawings. It is to be understood that the embodiments herein illustrated are examples only, and that the scope of the invention is to be defined solely by the claims when accorded a full range of equivalents.

We claim:

1. A Multimedia Terminating Device for providing multimedia content transmitted over a communication network and received from a broadband connection comprising:
broadband communication circuitry for receiving the multimedia content in a broadband format and extracting the content from the broadband format; and
decoder circuitry for receiving the content from the broadband communication circuitry, decoding the content and providing the decoded content to at least one user device based on the type of content.

2. The module of claim 1 wherein the broadband communication circuitry includes cable modem circuitry.

3. The module of claim 2 wherein the broadband format is DOCSIS.

4. The module of claim 1 wherein the decoder circuitry includes a digital signal processor.

5. The module of claim 1 wherein the decoder circuitry includes a graphics processor.

6. The module of claim 1 wherein the broadband communication circuitry and the decoder circuitry are interconnected using a bus interface between a MAC of the broadband communication circuitry and a MAC of the decoder circuitry.

7. The module of claim 1 wherein the decoder circuitry includes an audio output.

8. The module of claim 1 wherein the decoder circuitry includes at least one video output.

9. The module of claim 1 wherein the decoder circuitry includes a digital data connection host for connecting an external digital device.

10. The module of claim 9 wherein the external device is a hard disk drive.

11. A method for transporting a digital multimedia content over a broadband network from a central location to one or more subscribers:
converting the digital multimedia content in a digital multimedia content signal at the central location;
formatting the digital content signal into a broadband-transport-format signal;
transporting the broadband-formatted digital content signal toward the subscribers;
receiving the broadband-formatted digital content signal with broadband communication circuitry;
extracting the digital multimedia content from the broadband-transport-format signal; and
providing the digital multimedia content at one or more outputs according to content type.

12. The method of claim 11 wherein the broadband-transport-format signal is a DOCSIS signal.

13. The method of claim 11 wherein the broadband communication circuitry is cable modem circuitry.

14. The method of claim 11 wherein one of the outputs is a video output.

15. The method of claim 11 wherein one of the outputs is an audio output.

16. The method of claim 11 wherein one of the outputs is a digital data host output.

17. The method of claim 12 further comprising applying DOCSIS features to the broadband-transport-format signal to improve the transport thereof.

18. The method of claim 17 wherein a Dynamic Service Flow MIB is used to reduce jitter.

19. The method of claim 17 wherein Dynamic Channel Change is applied at the broadband communication circuitry to select a transport channel based on bandwidth needed for the type of content contained in the broadband-formatted digital content signal.
